(19) United States
(12) Patent Application Publication
(10) Pub. No.: US 2001/0042273 A1
(43) Pub. Date: Nov. 22, 2001

(54) Fastener for use with a fastening element and an inflatable device for use with the fastener

(76) Inventor: Robert B. Chaffee, Boston, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/862,858

(22) Filed: May 22, 2001

Related U.S. Application Data
(60) Provisional application No. 60/206,172, filed on May 22, 2000.

(51) Int. Cl. B68G 5/00; A47C 16/00; A47C 20/02

(52) U.S. Cl. 5/655.3

(57) ABSTRACT

The application relates to fasteners for use in securing two objects together with a fastening element and to an inflatable device incorporating such fasteners. In one embodiment, a fastener for use with a fastening element includes a housing sized and adapted to mate with a fastening element and a latch positioned relative to the housing to retain the fastening element within the housing.

This patent application claims priority to U.S. Provisional Patent Application No. 60/206,172, filed May 22, 2000.

### BACKGROUND

1. Field of the Application

The application relates to fasteners for use in securing two objects together with a fastening element, such as a button, and to an inflatable device incorporating such fasteners.

2. Related Art

Buttons are fasteners typically used to join together two sheets of material, such as cloth. Conventionally, a button is semi-permanently attached to one sheet, such as by thread. A mating buttonhole is formed in the other sheet where the button is to be attached. A typical buttonhole consists of a slit long enough to pass the button through when the button is properly oriented. When the button is properly oriented and passed through the buttonhole, the two sheets are connected until the button is once again oriented to pass through the buttonhole. In order to facilitate manually orienting the button to pass through the buttonhole, the buttonhole is typically placed near the edge of a sheet to provide ready access to the button on the reverse side of the sheet.

### SUMMARY

In one embodiment, the application is directed to a fastener including a housing sized and adapted to mate with a fastening element and a latch positioned relative to the housing to retain the fastening element within the housing.

In another embodiment, the application is directed to a device adapted to contain a fluid, including a substantially impermeable fluid bladder, a housing connected to the bladder and sized and adapted to mate with a fastening element and a latch positioned relative to the housing to retain the fastening element within the housing.

In another embodiment, the application is directed to a fastener assembly including a fastening element, a housing sized and adapted to mate with the fastening element and a latch positioned relative to the housing to retain the fastening element within the housing.

### BRIEF DESCRIPTION OF THE DRAWINGS

The application will be better understood and its advantages more apparent in view of the following detailed description, especially when read with reference to the appended drawings, wherein:

FIG. 1 is a perspective, plan view of a fastener according to one embodiment of the application;

FIG. 2 is a top, plan view of the fastener of FIG. 1;

FIG. 3 is a side, cross-sectional view of the fastener of FIG. 1 along line 3-3 of FIG. 2;

FIG. 4 is a front, cross-sectional view of the fastener of FIG. 1 along line 4-4 of FIG. 3;

FIG. 5 is a side, cross-sectional view of the fastener of FIG. 1 along line 3-3 of FIG. 2;

FIG. 6 is a side, cross-sectional view of the fastener of FIG. 1 along line 3-3 of FIG. 2;

FIG. 7 is a side, cross-sectional view of the fastener of FIG. 1 along line 3-3 of FIG. 2;

FIG. 8 is a top, plan view of an inflatable device according to one embodiment of the application;

FIG. 9 is a perspective, plan view of an inflatable device according to one embodiment of the application;

FIG. 10 is a front, plan view of an inflatable device according to one embodiment of the application; and

FIG. 11 is a side, cross-sectional view of the inflatable device of FIG. 10.

### DETAILED DESCRIPTION

It may be desirable to employ a fastening element, such as a button, as a mechanism of reversible attachment in situations that do not favor conventional use of the fastening element. Typically, connection by fastening element in the form of a button requires that the fastening element be passed through a buttonhole and that the buttonhole be located at or near an edge of the object containing the hole in order to provide access to the fastening element both above and below the hole as the fastening element is passed through it. However, for some devices, such as an inflatable device, it in not possible to provide a button hole in the membrane of the inflatable device. In order for a fastening element mounted on one surface to be attachable to another point on the surface, or to any point on another surface, a device is needed, mountable to the surface at the desired point of attachment, which will provide removable engagement with the fastening element.

In one embodiment, a fastener for use with a fastening element may include a housing sized and adapted to mate with a fastening element and a latch positioned relative to the housing to retain the fastening element within the housing. As used herein, the term “fastening element” refers to any structure that facilitates mating with the housing such as a generally planar structure that may be attached to an object to allow the object to be connected to another object. This definition of fastening element includes, for example, traditional sewn-on buttons, cuff-links, portions of a snap fastener, rivets, such as those often used as fastening elements with stiffer materials, such as denim, and the like.

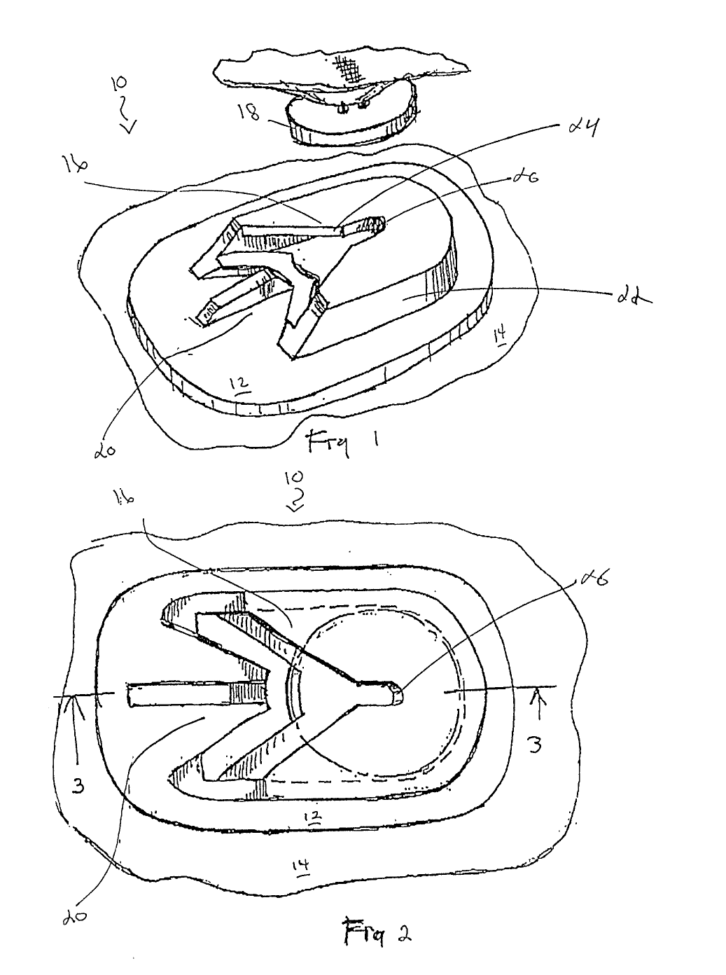

Referring now to the figures, one embodiment of a fastener according to the application will be described by way of example. As illustrated in FIG. 1, a fastener 10 for use with a fastening element 18 may include a housing 16 sized and adapted to mate with fastening element 18 and a latch 20 positioned relative to housing 16 to retain fastening element 18 within housing 16. It is to be appreciated that, although a conventional button is illustrated in FIGS. 1-7 as part of this embodiment of a fastener, other fastening elements that may mate with a housing, such as described infra and as defined herein, are intended to be within the scope of this application. Housing 16 and latch 20 may include any structure for positioning each relative to the other and that allows the latch and housing to function as intended. For example, both latch 20 and housing 16 may be attached to a common surface. In one embodiment, housing 16 and latch 20 are both connected to a flange 12.

In addition to positioning housing 16 and latch 20 in a spaced relationship to achieve an intended function of retaining the fastener element or button, flange 12 may also be used to connect fastener 10 to an object 14. For example, flange 12 may be used to connect fastener 10 to a sheet of material, such as a piece of cloth, or the wall of an inflatable bladder. Alternatively, housing 16 and/or latch 20 may be connected directly to object 14. Fastener 10 may be connected to object 14 in any manner that produces a connection that is strong and durable enough for the intended use of fastener 10. The manner of connection may vary, for example, with the desired durability of the connection and with the material of construction of fastener 10, flange 12 and object 14. For example, where fastener 10 is constructed of a polymeric material, particularly a thermoplastic, and object 14 is constructed of a similar material, fastener 10 may be heat sealed to object 14. As used herein, the phrase “heat sealed” refers to RF sealing, dielectric sealing, temperature sealing and the like. Materials having a similar durometer hardness are particularly suitable for heat sealing. Fastener 10 may also be connected to object 14 with an adhesive, stitching, or other known connection mechanisms.

Housing 16 may be constructed in any manner and using any materials that allow housing 16 to retain fastening element 18 in conjunction with latch 20. For example, housing 16 may enclose a portion of fastening element 18. In one embodiment, housing 16 includes a side wall 22 and a retaining lip 24. Side wall 22 may be constructed in any manner in which it inhibits fastening element 18 from detaching from housing 16 without passing latch 20. For example, side wall 22 may extend around the sides of fastening element 18 that do not interface with latch 20. Side wall 22 may be constructed to fit snugly with fastening element 18. For example, side wall 22 may be rounded to match the contour of fastening element 18 where fastening element 18 is round. Side wall 22 may also be constructed and arranged not to interfere with inserting fastening element 18 within housing 16. For example, side wall 22 may include an opening sufficient to allow insertion of fastening element 18 or may only extend to some of the sides of fastening element 18. In some embodiments, side wall 22 is not a continuous structure, but consists of several smaller walls, posts, or the like. Other configurations are also possible, so long as the function of retaining fastening element 18 is performed.

Lip 24 may be included as part of housing 16 to further secure fastening element 18 within housing 16. For example, lip 24 may extend from the top of side wall 22 as far as required to sufficiently retain fastening element 18 within housing 16. Lip 24 also may accommodate the attachment mechanism of the fastening element. For example, as most fastening elements are secured to an object at the fastening element's center, lip 24 may include a notch 26 to accommodate a fastening element attachment mechanism, such as thread. Side wall 22 and lip 24 need not be constructed as a single piece, but may consist, for example, of one or more protrusions that retain fastening element 18 within housing 16.

In some embodiments, housing 16 may include a material or structure that facilitates housing 16's connection to fastening element 18. For example, housing 16 may have a material in the inside that has a high coefficient of friction with the material of fastening element 18. Alternatively, housing 16 may have a structure, such as ribs or other roughened surface, that increases the coefficient of friction between housing 16 and fastening element 18.

Housing 16 may be constructed of any material sufficiently durable to retain fastening element 18. Preferably, housing 16 is constructed from a material that is inexpensive and easy to work with. From the standpoints of simplicity of construction and durability, it is also preferred that housing 16, latch 20 and any side wall 22, lip 24 or flange 12 be constructed of a single material and as a single piece. In some embodiments housing 16 may be constructed from a variety of durable polymers, such as polyvinyl chloride (PVC) or polyester. In other embodiments, housing 16 and the related components may be constructed of a variety of metals, such as aluminum or steel. Preferably, the material that latch 20 and/or housing 16 is constructed from is flexible. A flexible latch 20 allows latch 20 to be moved to allow fastening element 18 into and out of housing 16. Alternatively, or in addition, housing 16 may be flexible to allow fastening element 18 into and out of housing 16. Operation of an example embodiment where both latch 20 and housing 16 are flexible is illustrated in FIGS. 5-7. However, it will be recognized that neither housing 16, nor latch 20 need be flexible if, for example, fastening element 18 is flexible enough to allow it to be moved into and out of housing 16.

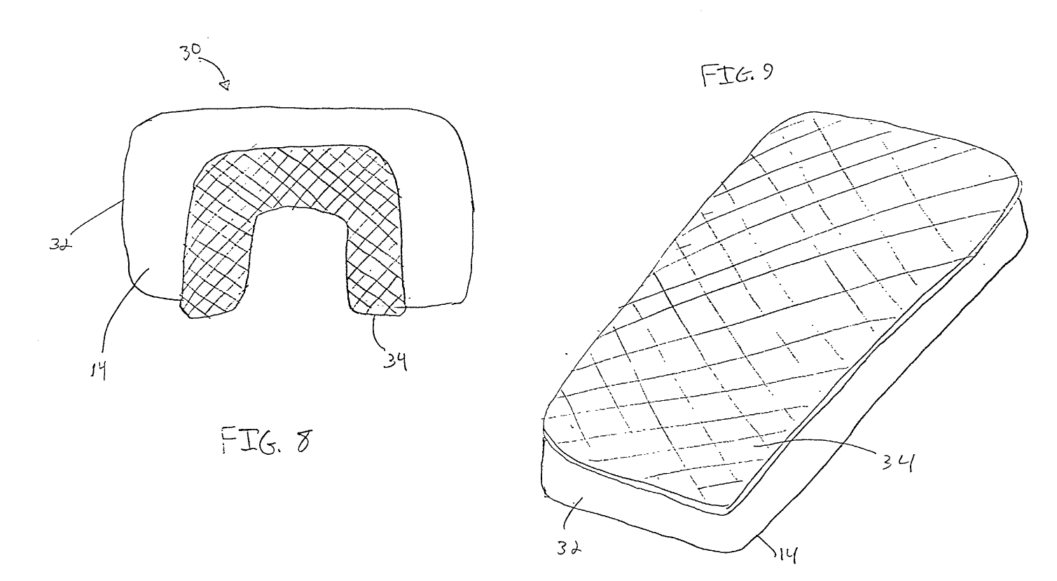

Latch 20 may be constructed in any manner and of any material(s) that allow latch 20 to work in conjunction with housing 16. In some embodiments, latch 20 may be discrete structure, however, in others it may, for example, be a part of housing 16 or include part of flange 12. For example, latch 20 may comprise of one or more protrusions from housing 16, such as from side wall 22. In either case, latch 20 is preferably placed on an open side of housing 16 to retain fastening element 18 within housing 16. Where latch 20 is placed on an open side of housing 16, it may inhibit fastening element 18 from escaping housing 16 until latch 20 is moved out of the path of fastening element 18. In one embodiment, latch 20 is flexible and may be moved out of the path of fastening element 18 by flexing it. For example, in the embodiment illustrated in FIG. 6, latch 20 flexes when pressure is applied, moving out of the path of fastening element 18. From this embodiment, it should be understood that latch 20 may include the entire portion of fastener 10 that flexes to allow fastening element 18 to be removed from housing 16. For example, in the embodiment illustrated in FIG. 6, flange 12 does part of the flexing and can be considered to be a portion of latch 20.

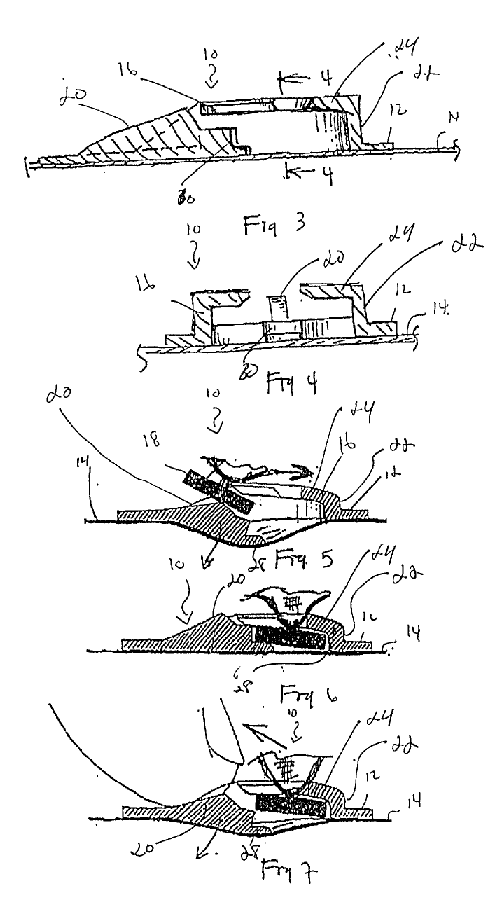

In another embodiment, latch 20 is articulated such that it may be moved out of the path of fastening element 16 without flexing. For example, latch 20 may be constructed to pivot out of the way of fastening element 18 or to be detachable from object 14 or flange 12. Preferably, latch 20 is constructed to securely hold fastening element 18 within housing 16. For example, latch 20 may be constructed to fit snugly with fastening element 18, such as by being shaped to fit fastening element 18. For example, latch 20 is illustrated in FIGS. 3 and 4 as contoured at one end 60 to the shape of fastening element 18 and may also comprise a lip under which fastening element 18 may be disposed when in the latched position.

It some embodiments, the fastener may include structure to facilitate operation of fastener 10 and to ensure that fastening element 18 does not become trapped within housing 16. For example, referring to FIGS. 5-6, where fastening element 18 might become disposed between latch 20 and object 14, a structure may be used to prevent this from occurring. For example, in one embodiment, a flange 28 is located at the base of latch 20 and projects under fastening element 18 and into housing 16 in a direction roughly parallel to a base of housing 16. A similar arrangement may be used to prevent fastening element 18 from getting in between housing 16 and object 14, where appropriate.

It is to be appreciated that, in some embodiments, the fastener of the application provides a mechanism for connection/attachment by a fastening element in applications where a conventional buttonhole is not available or practical. In particular, the fastener is usable in situations where at least one of the objects to be connected will accept installation of a fastening element, and at least one of the objects will accept installation of the housing.

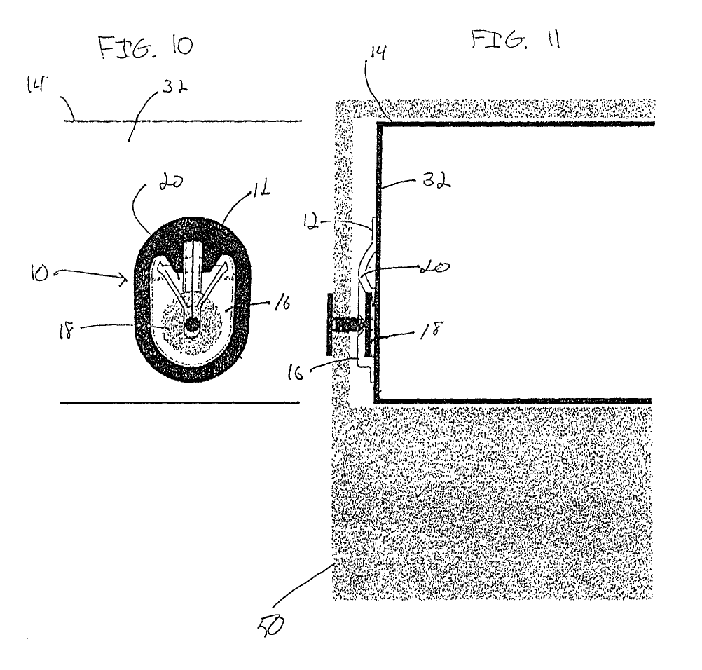

It is also to be appreciated that adaptations unique to the fastener eliminate the need for a through hole for passing the fastening element through one of the objects being attached, as is typically required in order to secure both objects in a mated position. The fastener thus enables the object that would ordinarily contain the “buttonhole” to be a substantially uninterrupted surface, free of holes.

Where one of the objects to be attached by a fastener according to an embodiment of the application is a membrane serving as a bladder for fluid containment, the fastener can, for example, be directly attached to the bladder surface. Surface continuity is important to the bladder's ability to contain fluid; as the through-hole of conventional fastening element fastening may be eliminated, the bladder membrane may therefore remain uninterrupted with the fastener of this application. Accordingly, the fastener is particularly useful with fluid-containing bladders. Such uses may include providing covers for such bladders, such as a comfort layer to a pillow or mattress, as illustrated in FIGS. 8 and 9. The fastener provides the further advantage that not all of a bladder need be covered with a layer, as may be required where there is no ready means to secure the layer to the bladder. Where the layer is a comfort layer, only those portions of the bladder that would come into contact with the user need be covered by the comfort layer. For example, as illustrated in FIG. 8, where the bladder 32 is a traveler's pillow 30 designed to support a person's head during upright rest, the comfort layer 34 need only cover the neck area and immediately surrounding region of the bladder. Similarly, as illustrated in FIG. 9, where bladder 32 is an air mattress, the comfort layer 34 need only cover the upper portion of the bladder.

The fastener may also be used to secure a bladder in a fixed location. For example, where a bladder is used in a folding bed or sofa bed, it may tend to move relative to the frame when it is folded or stowed. The fastener of the application may hold the bladder relative to the frame and, in some embodiments, may provide a more secure connection than a conventional snap fastener. The problem of shifting of the bladder during folding may also be encountered where the bladder is located within a outer cover. For example, as illustrated in FIGS. 10 and 11, a bladder 32 may be installed in a larger mattress 50. Mattress 50 may range in complexity from a simple mattress cover to a more complex structure including comfort layers and conventional mattress springs. When mattress 50 is folded, bladder 20 may undesirably shift within mattress 50. In the embodiment illustrated in FIGS. 10 and 11, this undesirable shifting is inhibited by connecting bladder 32 to the inside of mattress 50 with fastener 10, for example at the ends of bladder 20.

Applications of the fastener to a bladder may include the further benefit that the inflation of the bladder may further secure the fastening element within the fastener and may make the fastener less flexible, more securely retaining the fastening element within the fastener when the bladder is full.

Embodiments of the fastener of the application may find utility in many applications apart from a fluid containing bladder. In addition to being able to replace a conventional buttonhole in any application, the fastener may, for example, be used on water-impermeable sportswear, such as expanded polytetrafluoroelthylene (PTFE) fabrics. The fastener may also be used where one of the objects to be attached would have its integrity breached by the formation of a fastening element hole, such as in the case of fabrics that are easily torn. The fastener may also be used in a variety of applications where the back of the object that would receive the buttonhole in a typical application is not readily accessible. This may provide considerably more freedom in the location of fastening element attachments in clothing, sporting goods, bedding, and the like. Other non-conventional applications, such as a storage rack comprising numerous fasteners according to an embodiment of the application, are also facilitated by the fastener.

In some embodiments, fastener 10 may be used without being attached to an object 14 and/or may be used without a backing. In one such embodiment, fastener 10 is formed in a sheet of material. For example, fastener 10 may be formed in a sheet of thermoplastic material as the thermoplastic material is formed into the sheet. In another such embodiment, fastener 10 is installed into a hole in a sheet of material. It should be clear from these examples that fastener 10 may be capable of retaining fastening element 18 absent any backing device, such as in the form of object 14. On the other hand, in other embodiments, fastener 10 may comprise a backing of its own, such as an extension of housing 16.

It will be understood that each of the elements of the fastener and inflatable device described herein, or two or more together, may be modified or may also find utility in other applications differing from those described above. While particular embodiments of the fastener and inflatable device of the application have been illustrated and described, it is not intended to be limited to the details shown, since various modifications and substitutions may be made without departing in any way from the spirit of the application as defined by the following claims.

What is claimed is:

1. A fastener, comprising:
a housing sized and adapted to mate with a fastening element; and
a latch positioned relative to the housing to retain the fastening element within the housing.

2. The fastener of claim 1, further including a flange and wherein the housing and the latch are both connected to the flange.

3. The fastener of claim 2, wherein the flange is configured so that it can be connected to a sheet of material.

4. The fastener of claim 3, wherein each of the flange and sheet of material comprise a thermoplastic and the flange and sheet of material are heat sealed together.

5. The fastener of claim 1, wherein the housing comprises a side wall and a retaining lip.

6. The fastener of claim 5, wherein the retaining lip comprises a notch to accommodate a fastening element attachment mechanism.

7. The fastener of claim 5, wherein the side wall comprises a semi-circular section.

8. The fastener of claim 1, wherein the housing is flexible.

9. The fastener of claim 1, wherein the latch is flexible.

10. The fastener of claim 1, wherein the latch comprises a flange generally parallel to a base of the housing and projecting towards the interior of the housing.

11. The fastener of claim 1, wherein the latch comprises a protrusion having a portion corresponding to the shape of the fastening element.

12. The fastener of claim 1, wherein the fastener is formed in a sheet of material.

13. A fastener assembly, comprising:
a fastening element
a housing connected to the bladder and sized and adapted to mate with the fastening element; and
a latch positioned relative to the housing to retain the fastening element within the housing.

14. The fastener of claim 13, wherein the fastening element is flexible.

15. The fastener of claim 13, wherein the housing is flexible.

16. A device adapted to contain a fluid, comprising:
a substantially impermeable fluid bladder;
a housing sized and adapted to mate with a fastening element; and
a latch positioned relative to the housing to retain the fastening element within the housing.

17. The device adapted to contain a fluid of claim 16, further comprising a flange wherein the housing and the latch are connected to the flange and the flange is connected to the substantially fluid impermeable bladder.
